(19) United States
(12) Patent Application Publication
(10) Pub. No.: US 2015/0187487 A1
(43) Pub. Date: Jul. 2, 2015

(54) CERAMIC ELECTRONIC COMPONENT

(71) Applicant: SAMSUNG ELECTRO-MECHANICS CO., LTD., Suwon-Si (KR)

(72) Inventors: Sung Jin PARK, Suwon-Si (KR); Hyeog Soo SHIN, Suwon-Si (KR)

(21) Appl. No.: 14/478,792

(22) Filed: Sep. 5, 2014

(30) Foreign Application Priority Data
Jan. 2, 2014 (KR) 10-2014-0000287

(51) Int. Cl. H01F 27/29; H01F 27/28

(52) U.S. Cl. CPC H01F 27/29; H01F 27/2804; H01F 2027/2809

(57) ABSTRACT

A ceramic electronic component may include: a chip body; external electrode forming portions formed on both ends of the chip body in a length direction, on at least one of an upper surface and a lower surface of the chip body, respectively; external electrodes formed on the external electrode forming portions, respectively; and a protective layer formed between the external electrode forming portions and having a thickness greater than that of the external electrodes.

### CROSS-REFERENCE TO RELATED APPLICATION

This application claims the benefit of Korean Patent Application No. 10-2014-0000287 filed on Jan. 2, 2014, with the Korean Intellectual Property Office, the disclosure of which is incorporated herein by reference.

### BACKGROUND

The present disclosure relates to a ceramic electronic component.

In general, electronic components using ceramic materials include capacitors, inductors, piezoelectric elements, varistors, thermistors, and the like.

An inductor, one of the ceramic electronic components, is an important passive element configuring an electronic circuit together with a resistor and a capacitor and may be used to remove noise or may be used in a component configuring an LC resonance circuit.

Inductors may be classified into several types of inductors such as a wire wound type inductor, a thin type inductor, a multilayer type inductor, and the like, depending on structures thereof. The wire wound type inductor or the thin inductor may be manufactured by winding or printing a coil around or on a ferrite core and subsequently, forming electrodes at both ends thereof. The multilayer type inductor may be manufactured by printing internal electrode patterns on dielectrics, sheets formed of dielectrics, or the like, and subsequently, stacking a plurality of the dielectric sheets having the internal electrode patterns printed thereon.

Among them, the multilayer type inductor has advantages such as miniaturization and slimness of a product as compared to the wire wound type inductor and is also advantageous in terms of improving direct current (DC) resistance, as compared to a wire wound type inductor, such that the multilayer type inductor is mainly used in a power supply circuit requiring the miniaturization and an increase in a current of a product.

Generally, in the multilayer type inductor, conductors are printed in a coil shape on a plurality of dielectric layers stacked in a thickness direction to form internal electrode patterns, and the internal electrode patterns are vertically connected to each other to form a coil part.

The coil part may be led to both end surfaces of a chip in a length direction, and an external electrode may be formed to be connected to the coil part led to both end surfaces of the chip.

However, in the multilayer type inductor according to the related art as described above, since the external electrode is formed at a position higher than that of an upper surface of a chip body, in the case in which a case formed of a metal contacts the external electrode, a short-circuit may occur.

The following Patent Document 1 relates to a multilayer type inductor having secured stability even when external mechanical impacts are applied thereto.

### RELATED ART DOCUMENT

(Patent Document 1) Korean Patent Laid-Open Publication No. 2013-0112241

### SUMMARY

An exemplary embodiment in the present disclosure may provide a ceramic electronic component having improved reliability.

According to an exemplary embodiment in the present disclosure, a ceramic electronic component may include: a chip body; external electrode forming portions formed on both ends of the chip body in a length direction, on at least one of an upper surface and a lower surface of the chip body, respectively; external electrodes formed on the external electrode forming portions, respectively; and a protective layer formed between the external electrode forming portions and having a thickness greater than that of the external electrodes.

The protective layer may be formed of one or more selected from a group consisting of nickel (Ni) ferrite, zinc (Zn) ferrite, copper (Cu) ferrite, manganese (Mn) ferrite, cobalt (Co) ferrite, barium (Ba) ferrite, nickel-zinc-copper (Ni—Zn—Cu) ferrite, and a Fe-based metal magnetic material.

The external electrodes may have widths smaller than that of the chip body.

The external electrode forming portions may be formed on the upper and lower surfaces of the chip body.

The external electrodes may be extended from the external electrode forming portions to a portion of side surfaces of the chip body, respectively.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic perspective view of a ceramic electronic component according to an exemplary embodiment of the present disclosure;

FIG. 2 is a schematic cross-sectional view taken along line A-A′ of FIG. 1; and

FIG. 3 is a plan view of the ceramic electronic component according to an exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

Directions will be defined in order to clearly describe an exemplary embodiment of the present disclosure. In the accompanying drawings, X, Y and Z refer to a length direction, a width direction, and a thickness direction of an element, respectively.

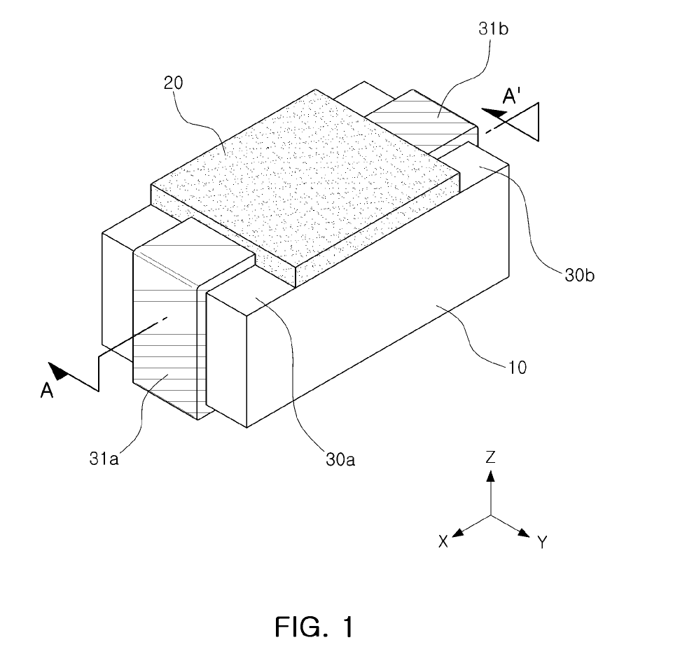

FIG. 1 is a schematic perspective view of a ceramic electronic component according to an exemplary embodiment of the present disclosure. FIG. 2 is a schematic cross-sectional view taken along line A-A′ of FIG. 1.

A structure of a ceramic electronic component according to an exemplary embodiment of the present disclosure will be described with reference to FIGS. 1 and 2.

The ceramic electronic component according to an exemplary embodiment of the present disclosure may include a chip body 10, a protective layer 20, external electrode forming portions 30a and 30b, and external electrodes 31a and 31b.

The chip body 10 may be formed by forming coil patterns 11 on a plurality of magnetic layers and subsequently, stacking, pressing, and sintering the plurality of magnetic layers.

After the magnetic layers are pressed and sintered, the magnetic layers adjacent to each other may be integrated with each other so that boundaries therebetween are not readily apparent without a scanning electron microscope (SEM).

The magnetic layers may be formed of a ferrite-based material or a mixture of an organic material and a metal, but are not limited thereto.

The coil patterns 11 may be formed on the magnetic layers at a predetermined thickness, using a conductive paste.

The coil patterns 11 may be connected to one another in a thickness direction through via electrodes 12 to configure a coil forming an inductance.

Here, the coil patterns 11, respectively positioned on different magnetic layers, may be electrically insulated from each other by the magnetic layers.

In addition, the coil patterns 11 may be formed to have a loop shape along a circumference of the magnetic layer in order to increase inductance. Preferably, the coil patterns 11 may be formed to have a shape as close to a loop as possible along the circumference of the magnetic layer.

In addition, a conductive metal contained in the conductive paste forming the coil patterns 11 may be one of silver (Ag), palladium (Pd), platinum (Pt), nickel (Ni), and copper (Cu), or an alloy thereof. However, the present disclosure is not limited thereto.

In addition, methods of printing the conductive paste may include a screen printing method, a gravure printing method, and the like. However, the present disclosure is not limited thereto.

One end portions of at least some of the coil patterns 11 may be led to end surfaces of the chip body 10.

Here, lead portions of the coil patterns 11 may be formed to have same widths as those of the coil patterns 11 in the chip body 10. Alternatively, the lead portions of the coil patterns 11 may be formed to have widths larger than those of the coil patterns 11 in the chip body 10, if necessary, to allow for improvements in electrical connectivity between the external electrodes 31a and 31b and the lead portions of the coil patterns 11.

The chip body 10 may have a hexahedron shape having upper and lower surfaces, but is not limited thereto.

The chip body 10 may have the external electrode forming portions 30a and 30b formed on at least one of the upper and lower surfaces thereof so that the external electrodes 31a and 31b may be formed thereon.

The external electrodes 31a and 31b may be formed at a predetermined thickness on the external electrode forming portions 30a and 30b of the chip body 10, respectively, using a conductive paste. The conductive paste may contain sliver (Ag), nickel (Ni), and copper (Cu), or an alloy thereof, but is not limited thereto.

The external electrodes 31a and 31b may be electrically connected to the lead portions of the coil patterns 11 exposed to end surfaces of the chip body 10 and may be electrically connected to the coil patterns 11 through conductive vias (not shown), if necessary.

The external electrodes 31a and 31b may be extended from the external electrode forming portions 30a and 30b to side surfaces of the chip body 10, respectively, to improve adhesion properties between the external electrodes and the chip body.

Further, in order to further improve the adhesion properties, the external electrodes 31a and 31b may be extended to at least a portion of the lower surface of the chip body 10.

The external electrode forming portions 30a and 30b may have the protective layer 20 formed therebetween.

A thickness Tp of the protective layer 20 may be greater than a thickness Te of the external electrodes 31a and 31b.

For example, 1.1Te≦Tp≦Te may be satisfied.

In the case in which Tp is less than 1.1Te, the possibility of causing short-circuits may increase, and in the case in which Tp exceeds 3Te, a volume of the chip body may be relatively reduced, such that an inductance may be decreased.

Therefore, the thickness Tp of the protective layer 20, as compared to the thickness Te of the external electrodes 31a and 31b may be formed such that 1.1Te≦Tp≦Te may be satisfied. Thus, the occurrence of short-circuits may be prevented and the inductance may be increased.

Since the protective layer 20 has a thickness greater than that of the external electrodes 31a and 31b, contact between a case formed of a metal and the external electrodes 31a and 31b may be prevented to prevent the occurrence of the short-circuits.

Therefore, reliability of the ceramic electronic component according to an exemplary embodiment of the present disclosure may be improved.

The protective layer 20 may be formed of the same material as that of the magnetic layer included in the chip body 10, but is not limited thereto.

For example, the protective layer 20 may be formed of one or more selected from a group consisting of nickel (Ni) ferrite, zinc (Zn) ferrite, copper (Cu) ferrite, manganese (Mn) ferrite, cobalt (Co) ferrite, barium (Ba) ferrite, nickel-zinc-copper (Ni—Zn—Cu) ferrite, and a Fe-based metal magnetic material.

The protective layer 20 may be formed of the magnetic material to improve the inductance of the ceramic electronic component.

In the case in which the magnetic material used to form the protective layer 20 is the Fe-based metal magnetic material, the magnetic material may be mixed with a polymer resin such as an epoxy resin to form the protective layer 20.

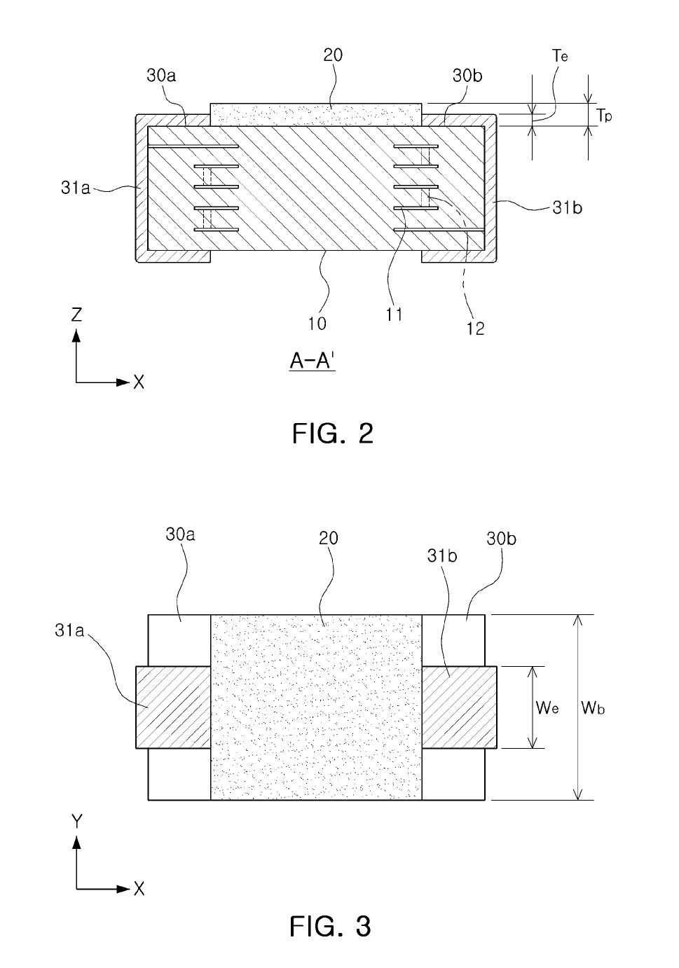

FIG. 3 is a plan view of the ceramic electronic component according to an exemplary embodiment of the present disclosure.

Referring to FIG. 3, a width We of each of the external electrodes 31a and 31b may be smaller than a width Wb of the chip body 10.

The external electrodes 31a and 31b may determine a size of the ceramic electronic component.

Generally, a chip may be manufactured in such a manner that the width We of each of the external electrodes 31a and 31b may be larger than the width Wb of the chip body 10.

However, in the ceramic electronic component according to an exemplary embodiment of the present disclosure, the width We of each of the external electrodes 31a and 31b may be smaller than the width Wb of the chip body 10, such that the width Wb of the chip body 10 may be relatively increased.

In the case in which the width Wb of the chip body 10 is increased, a volume of the magnetic material may be increased, such that an inductance may be increased.

In the ceramic electronic component according to an exemplary embodiment of the present disclosure, since the width We of each of the external electrodes 31a and 31b is smaller than the width Wb of the chip body 10, the volume of the chip body 10 may be increased.

The volume of the chip body 10 may be increased, such that the inductance of the ceramic electronic component may be increased.

Although a multilayer type inductor is described by way of example in an exemplary embodiment of the present disclosure described above, the present disclosure is not limited thereto.

For example, it may be obvious to those skilled in the art that embodiments of the present disclosure may also be applied to a wire wound type inductor and a thin type inductor.

As set forth above, according to exemplary embodiments of the present disclosure, the ceramic electronic component may include the protective layer having a thickness greater than the external electrodes, such that the occurrence of short-circuits may be prevented even in a case in which a case part formed of a metal is formed, thereby improving reliability of the component.

In addition, the protective layer may allow the external electrodes and the case to be spaced apart from each other by a predetermined distance, such that the occurrence of short-circuits may be prevented when external impacts are applied, thereby improving reliability of the component.

While exemplary embodiments have been shown and described above, it will be apparent to those skilled in the art that modifications and variations could be made without departing from the spirit and scope of the present disclosure as defined by the appended claims.

What is claimed is:

1. A ceramic electronic component comprising:
a chip body;
external electrode forming portions disposed on both ends of the chip body in a length direction, on at least one of an upper surface and a lower surface of the chip body;
external electrodes disposed on the external electrode forming portions, respectively; and
a protective layer disposed between the external electrode forming portions and having a thickness greater than that of the external electrodes.

2. The ceramic electronic component of claim 1, wherein the protective layer is formed of one or more selected from a group consisting of nickel (Ni) ferrite, zinc (Zn) ferrite, copper (Cu) ferrite, manganese (Mn) ferrite, cobalt (Co) ferrite, barium (Ba) ferrite, nickel-zinc-copper (Ni—Zn—Cu) ferrite, and a Fe-based metal magnetic material.

3. The ceramic electronic component of claim 1, wherein the external electrodes have widths smaller than that of the chip body.

4. The ceramic electronic component of claim 1, wherein the external electrode forming portions are formed on the upper and lower surfaces of the chip body.

5. The ceramic electronic component of claim 1, wherein the external electrodes are extended from the external electrode forming portions to a portion of side surfaces of the chip body.
